(19) United States
(12) Patent Application Publication
(10) Pub. No.: US 2025/0253587 A1
(43) Pub. Date: Aug. 7, 2025

(54) Connector Assembly and Electrical Connector Thereof

(71) Applicants: Dongguan Tarng Yu Electronics Co., Ltd., Dongguan City (CN); Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 19/028,382

(22) Filed: Jan. 17, 2025

(30) Foreign Application Priority Data
Feb. 2, 2024 (TW) 113104319

(51) Int. Cl. H01R 13/6471; H01R 13/50; H01R 13/6581; H01R 24/60

(52) U.S. Cl. CPC H01R 13/6471; H01R 13/50; H01R 13/6581; H01R 24/60

(57) ABSTRACT

A connector assembly and electrical connector thereof, wherein the electrical connector is configured to mate with a mating conductive component. The electrical connector comprises a conductive plastic base and a signal terminal. The signal terminal is configured to mate with the mating conductive component for signal transmission. The conductive plastic base is configured to provide shielding for the signal terminal to reduce the degree of interference with the signal transmission of the signal terminal, thereby satisfying the signal transmission requirements of the electrical connector.

### CROSS-REFERENCE TO RELATED APPLICATIONS

This application claims the priority of Republic of China Patent Application No. 113104319 filed on Feb. 2, 2024, in the State Intellectual Property Office of the R.O.C., the disclosure of which is incorporated herein by reference.

### BACKGROUND OF THE INVENTION

### Field of the Invention

This application relates to the technical field of electronic devices, and more specifically, to a connector assembly and electrical connector thereof that can provide shielding to signal terminals to meet signal transmission requirements.

### Descriptions of the Related Art

In recent years, electrical connectors have been widely applied to various electronic devices. However, with the special demands and advancements in electronic devices, the need for signal transmission in electrical connectors has been increasing day by day. Existing electrical connectors, limited by inadequate shielding effects due to mechanical design, often experience interference during signal transmission. This interference leads to issues such as attenuation and distortion in the signal transmission process, making it difficult for electrical connectors to meet signal transmission requirements. The interference may include, for example, EMI (Electromagnetic Interference) or crosstalk noise interference.

Therefore, how to reduce the interference experienced by electrical connectors during the signal transmission process is a pressing problem that those skilled in the art urgently need to solve.

### SUMMARY OF THE INVENTION

In view of the drawbacks of the prior art mentioned above, the present application provides an electrical connector, the electrical connector comprising: a conductive plastic base, the conductive plastic base comprising a first major conductive plastic base signal terminal non-mating side shielding structure, a second major conductive plastic base signal terminal non-mating side shielding structure, and a major conductive plastic base signal terminal mating side shielding structure, wherein the major conductive plastic base signal terminal mating side shielding structure, the first major conductive plastic base signal terminal non-mating side shielding structure, and the second major conductive plastic base signal terminal non-mating side shielding structure can extend to form a major conductive plastic base signal terminal root shielding space, and the first major conductive plastic base signal terminal non-mating side shielding structure and the second major conductive plastic base signal terminal non-mating side shielding structure can also extend to form a major conductive plastic base signal terminal mating shielding space; and a major signal terminal module, the major signal terminal module comprising a major signal terminal and a major signal terminal insulating core, wherein the major signal terminal comprises a major signal terminal root structure and a major signal terminal mating structure, wherein the major signal terminal root structure supports the major signal terminal mating structure, and the major signal terminal insulating core respectively positions the major signal terminal and the conductive plastic base, allowing the major signal terminal root structure to enter the major conductive plastic base signal terminal root shielding space, enabling the first major conductive plastic base signal terminal non-mating side shielding structure and the second major conductive plastic base signal terminal non-mating side shielding structure to respectively provide shielding for the major signal terminal root structure at a major non-mating side of the major signal terminal, and allows the major conductive plastic base signal terminal mating side shielding structure to provide shielding for the major signal terminal root structure at a major mating side of the major signal terminal, further allowing the major signal terminal mating structure enters the major conductive plastic base signal terminal mating shielding space, enabling the first major conductive plastic base signal terminal non-mating side shielding structure and the second major conductive plastic base signal terminal non-mating side shielding structure to respectively provide shielding for the major signal terminal mating structure on the major non-mating side.

Preferably, the electrical connector said above, wherein the conductive plastic base further comprises a major conductive plastic base signal terminal penetrating passage, and the major conductive plastic base signal terminal penetrating passage is located between the first major conductive plastic base signal terminal non-mating side shielding structure and the second major conductive plastic base signal terminal non-mating side shielding structure, to allow the major signal terminal to penetrate, preventing the conductive plastic base from interfering with the major signal terminal.

Preferably, the electrical connector said above, wherein the major conductive plastic base signal terminal mating side shielding structure is connected to the first major conductive plastic base signal terminal non-mating side shielding structure and the second major conductive plastic base signal terminal non-mating side shielding structure, forming a major conductive plastic base signal terminal shielding structure body, and the major conductive plastic base signal terminal shielding structure body is U-shaped.

Preferably, the electrical connector said above, further comprising: a major grounding terminal module, the major grounding terminal module comprising a first major grounding terminal and a second major grounding terminal, wherein the first major grounding terminal comprises a first major grounding terminal root structure and a first major grounding terminal mating structure, and the first major grounding terminal root structure provides support for the first major grounding terminal mating structure, and the second major grounding terminal comprises a second major grounding terminal root structure and a second major grounding terminal mating structure, and the second major grounding terminal root structure provides support for the second major grounding terminal mating structure, and the first major grounding terminal and the second major grounding terminal are respectively positioned by the conductive plastic base, enabling the first major grounding terminal root structure and the second major grounding terminal root structure to respectively enter the major conductive plastic base signal terminal root shielding space, allowing the first major grounding terminal root structure and the second major grounding terminal root structure to respectively provide shielding for the major signal terminal root structure on the major non-mating side, enabling the first major grounding terminal mating structure and the second major grounding terminal mating structure to respectively enter the major conductive plastic base signal terminal mating shielding space, allowing the first major grounding terminal mating structure and the second major grounding terminal mating structure to respectively provide shielding for the major signal terminal mating structure on the major non-mating side.

Preferably, the electrical connector said above, wherein the first major grounding terminal and the second major grounding terminal are respectively positioned by the first major conductive plastic base signal terminal non-mating side shielding structure and the second major conductive plastic base signal terminal non-mating side shielding structure.

Preferably, the electrical connector said above, wherein the first major conductive plastic base signal terminal non-mating side shielding structure comprises a first major conductive plastic base grounding terminal penetrating passage, and the second major conductive plastic base signal terminal non-mating side shielding structure comprises a second major conductive plastic base grounding terminal penetrating passage, and the first major conductive plastic base grounding terminal penetrating passage provides penetrating for the first major grounding terminal, and the second major conductive plastic base grounding terminal penetrating passage provides penetrating for the second major grounding terminal, preventing the first major conductive plastic base signal terminal non-mating side shielding structure from interfering with the first major grounding terminal, and preventing the second major conductive plastic base signal terminal non-mating side shielding structure from interfering with the second major grounding terminal.

Preferably, the electrical connector said above, wherein the major signal terminal is located on a major signal terminal projection plane, and the first major grounding terminal root structure projects on a first major grounding terminal root structure projection area on the major signal terminal projection plane, and the second major grounding terminal root structure projects on a second major grounding terminal root structure projection area on the major signal terminal projection plane, and the major signal terminal root structure is projected within the first major grounding terminal root structure projection area and the second major grounding terminal root structure projection area; and the first major grounding terminal mating structure projects on a first major grounding terminal mating structure projection area on the major signal terminal projection plane, and the second major grounding terminal mating structure projects on a second major grounding terminal mating structure projection area on the major signal terminal projection plane, and the major signal terminal mating structure is projected within the first major grounding terminal mating structure projection area and the second major grounding terminal mating structure projection area.

Preferably, the electrical connector said above, further comprising a bridging conductive component, the bridging conductive component comprising a bridging conductive component body, a first major bridging conductive component joining structure, and a second major bridging conductive component joining structure, wherein the bridging conductive component is positioned by the conductive plastic base, such that the bridging conductive component body spans across the major signal terminal, causing the first major bridging conductive component joining structure to join the first major grounding terminal, and the second major bridging conductive component joining structure to join the second major grounding terminal, allowing the bridging conductive component body to be electrically connected with the first major grounding terminal and the second major grounding terminal.

Preferably, the electrical connector said above, wherein the conductive plastic base further comprises a first minor conductive plastic base signal terminal non-mating side shielding structure, a second minor conductive plastic base signal terminal non-mating side shielding structure, and a minor conductive plastic base signal terminal mating side shielding structure, wherein the minor conductive plastic base signal terminal mating side shielding structure, the first minor conductive plastic base signal terminal non-mating side shielding structure, and the second minor conductive plastic base signal terminal non-mating side shielding structure form a minor conductive plastic base signal terminal root shielding space by extension, and the first minor conductive plastic base signal terminal non-mating side shielding structure and the second minor conductive plastic base signal terminal non-mating side shielding structure form a minor conductive plastic base signal terminal mating shielding space by extension; and the electrical connector further comprises: a minor signal terminal module, wherein the minor signal terminal module comprises a minor signal terminal and a minor signal terminal insulating core, the minor signal terminal comprising a minor signal terminal root structure and a minor signal terminal mating structure, wherein the minor signal terminal root structure supports the minor signal terminal mating structure, and the minor signal terminal insulating core respectively positions the minor signal terminal and the conductive plastic base, causing the minor signal terminal root structure to enter the minor conductive plastic base signal terminal root shielding space, such that the first minor conductive plastic base signal terminal non-mating side shielding structure and the second minor conductive plastic base signal terminal non-mating side shielding structure respectively provide shielding for minor signal terminal root structure on a the minor non-mating side of the minor signal terminal, and the minor conductive plastic base signal terminal mating side shielding structure provides shielding for the minor signal terminal root structure on the minor mating side of the minor signal terminal, allowing the minor signal terminal mating structure to enter the minor conductive plastic base signal terminal mating shielding space, such that the first minor conductive plastic base signal terminal non-mating side shielding structure and the second minor conductive plastic base signal terminal non-mating side shielding structure respectively provide shielding for the minor signal terminal mating structure on the minor non-mating side.

Preferably, the electrical connector said above, wherein the conductive plastic base further comprises a minor conductive plastic base signal terminal penetrating passage, the minor conductive plastic base signal terminal penetrating passage being located between the first minor conductive plastic base signal terminal non-mating side shielding structure and the second minor conductive plastic base signal terminal non-mating side shielding structure to provide penetrating for the minor signal terminal, while avoiding interference from the conductive plastic base with the minor signal terminal.

Preferably, the electrical connector said above, wherein the minor conductive plastic base signal terminal mating side shielding structure and the major conductive plastic base signal terminal mating side shielding structure are symmetrical structures.

Preferably, the electrical connector said above, wherein the minor conductive plastic base signal terminal mating side shielding structure is respectively connected to the first minor conductive plastic base signal terminal non-mating side shielding structure and the second minor conductive plastic base signal terminal non-mating side shielding structure to form a minor conductive plastic base signal terminal shielding structure body, the minor conductive plastic base signal terminal shielding structure body being a U-shaped structure body.

Preferably, the electrical connector said above, wherein the electrical connector further comprises a minor grounding terminal module, the minor grounding terminal module comprising a first minor grounding terminal and a second minor grounding terminal, the first minor grounding terminal comprising a first minor grounding terminal root structure and a first minor grounding terminal mating structure, wherein the first minor grounding terminal root structure provides support for the first minor grounding terminal mating structure, and the second minor grounding terminal comprising a second minor grounding terminal root structure and a second minor grounding terminal mating structure, wherein the second minor grounding terminal root structure provides support for the second minor grounding terminal mating structure, and the first minor grounding terminal and the second minor grounding terminal are respectively positioned by the conductive plastic base, such that the first minor grounding terminal root structure and the second minor grounding terminal root structure respectively enter the minor conductive plastic base signal terminal root shielding space, thereby causing the first minor grounding terminal root structure and the second minor grounding terminal root structure to respectively provide shielding for the minor signal terminal root structure on the minor non-mating side, and further causing the first minor grounding terminal mating structure and the second minor grounding terminal mating structure to respectively enter the minor conductive plastic base signal terminal mating shielding space, thereby causing the first minor grounding terminal mating structure and the second minor grounding terminal mating structure to respectively provide shielding for the minor signal terminal mating structure on the minor non-mating side.

Preferably, the electrical connector said above, wherein the first minor grounding terminal and the second minor grounding terminal are respectively positioned by the first minor conductive plastic base signal terminal non-mating side shielding structure and the second minor conductive plastic base signal terminal non-mating side shielding structure.

Preferably, the electrical connector said above, wherein the first minor conductive plastic base signal terminal non-mating side shielding structure comprises a first minor conductive plastic base grounding terminal penetrating passage, and the second minor conductive plastic base signal terminal non-mating side shielding structure comprises a second minor conductive plastic base grounding terminal penetrating passage, and the first minor conductive plastic base grounding terminal penetrating passage provides penetrating for the first minor grounding terminal, and the second minor conductive plastic base grounding terminal penetrating passage provides penetrating for the second minor grounding terminal, while avoiding interference from the first minor conductive plastic base signal terminal non-mating side shielding structure with the first minor grounding terminal, and avoiding interference from the second minor conductive plastic base signal terminal non-mating side shielding structure with the second minor grounding terminal.

Preferably, the electrical connector said above, wherein the first minor grounding terminal is located on a minor signal terminal projection plane, and the first minor grounding terminal root structure projects in a first minor grounding terminal root structure projection area on the minor signal terminal projection plane, and the second minor grounding terminal root structure projects in a second minor grounding terminal root structure projection area on the minor signal terminal projection plane, and the minor signal terminal root structure is projected in the first minor grounding terminal root structure projection area and the second minor grounding terminal root structure projection area; and the first minor grounding terminal mating structure projects in a first minor grounding terminal mating structure projection area on the minor signal terminal projection plane, and the second minor grounding terminal mating structure projects in a second minor grounding terminal mating structure projection area on the minor signal terminal projection plane, and the minor signal terminal mating structure is projected in the first minor grounding terminal mating structure projection area and the second minor grounding terminal mating structure projection area.

Preferably, the electrical connector said above, wherein the electrical connector further comprises a bridging conductive component, the bridging conductive component comprising a bridging conductive component body, a first minor bridging conductive component joining structure, and a second minor bridging conductive component joining structure, the bridging conductive component being positioned by the conductive plastic base, so that the bridging conductive component body spans over the minor signal terminal, causing the first minor bridging conductive component joining structure to be joined to the first minor grounding terminal, and causing the second minor bridging conductive component joining structure to be joined to the second minor grounding terminal, so that the bridging conductive component body electrically connects the first minor grounding terminal and the second minor grounding terminal.

Preferably, the electrical connector said above, wherein the bridging conductive component body is located between the major signal terminal module and the minor signal terminal module.

Furthermore, this application further provides a connector assembly, the connector assembly comprising: the electrical connector; and a mating conductive component, the mating conductive component comprising a major mating conductive component signal terminal mating structure, the mating conductive component being mated with the electrical connector, so that the major mating conductive component signal terminal mating structure mates with the major signal terminal mating structure within the major conductive plastic base signal terminal mating shielding space, wherein, when the mating conductive component is mated with the electrical connector, the major mating conductive component signal terminal mating structure is located on the major mating side.

Preferably, the connector assembly said above, the connector assembly comprising: the electrical connector; and a mating conductive component, the mating conductive component comprising a major mating conductive component signal terminal mating structure and a first minor mating conductive component signal terminal mating structure, the mating conductive component being mated with the electrical connector, so that the major mating conductive component signal terminal mating structure mates with the major signal terminal mating structure within the major conductive plastic base signal terminal mating shielding space, and the minor mating conductive component signal terminal mating structure mates with the minor signal terminal mating structure within the minor conductive plastic base signal terminal mating shielding space, wherein, when the mating conductive component is mated with the electrical connector, the major mating conductive component signal terminal mating structure is located on the major mating side of the major signal terminal, and the minor mating conductive component signal terminal mating structure is located on the minor mating side.

Compared to the prior art, the present application provides a connector assembly and its electrical connector. The electrical connector is configured to mate with a mating conductive component. The electrical connector comprises a conductive plastic base and a signal terminal. The signal terminal is configured to mate with the mating conductive component for signal transmission. The conductive plastic base is configured to provide shielding for the signal terminal to reduce the degree of interference with the signal transmission of the signal terminal, thereby satisfying the signal transmission requirements of the electrical connector.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of a first perspective of the connector assembly in an embodiment of the present application.

FIG. 2 is a three-dimensional schematic view of a second perspective of the connector assembly in an embodiment of the present application.

FIG. 3 is a three-dimensional schematic view of a first perspective of the electrical connector in an embodiment of the present application.

FIG. 4 is a three-dimensional schematic view of a second perspective of the electrical connector in an embodiment of the present application.

FIG. 5 is a three-dimensional schematic view of a first perspective of the electrical connector in an embodiment of the present application.

FIG. 6 is a three-dimensional schematic view of a second perspective of the electrical connector in an embodiment of the present application.

FIG. 7 is a top view schematic diagram of the electrical connector in an embodiment of the present application.

FIG. 8 is a sectional schematic diagram of a portion of the electrical connector shown in FIG. 7, taken along line AA.

FIG. 9 is a front view schematic diagram of the electrical connector in an embodiment of the present application.

FIG. 10 is a sectional schematic diagram of a portion of the electrical connector shown in FIG. 9, taken along line BB.

FIG. 11 is a sectional schematic diagram of a portion of the electrical connector shown in FIG. 9, taken along line CC.

FIG. 12 is a three-dimensional schematic view of a portion of the electrical connector in an embodiment of the present application.

FIG. 13 is a top view schematic diagram of a portion of the electrical connector in an embodiment of the present application.

FIG. 14 is a front view schematic diagram of a portion of the electrical connector in an embodiment of the present application.

FIG. 15 is a three-dimensional schematic view of a first perspective of the conductive plastic base in an embodiment of the present application.

FIG. 16 is a three-dimensional schematic view of a second perspective of the conductive plastic base in an embodiment of the present application.

FIG. 17 is a three-dimensional schematic view of a portion of the electrical connector in an embodiment of the present application.

FIG. 18 is a three-dimensional schematic view of a portion of the electrical connector in an embodiment of the present application.

FIG. 19 is a three-dimensional schematic view of a portion of the electrical connector in an embodiment of the present application.

FIG. 20 is a three-dimensional schematic view of a portion of the electrical connector in an embodiment of the present application.

FIG. 21 is a front view schematic diagram of the electrical connector in an embodiment of the present application.

FIG. 22 is a sectional schematic diagram of a portion of the electrical connector shown in FIG. 21, taken along line DD.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Furthermore, in the following embodiments, structures or components with identical or similar functions will be denoted using the same symbols, and the descriptions of identical or equivalent technical features will be omitted to make the disclosed content more concise and easier to understand.

The present application provides at least one connector assembly and electrical connector thereof, wherein the electrical connector is mated with a mating conductive component. The electrical connector comprises a conductive plastic base and a signal terminal, wherein the signal terminal is configured to mate with the mating conductive component to transmit signals, and the conductive plastic base is configured to provide shielding for the signal terminal, thereby reducing the degree of interference affecting the signal transmission of the signal terminal and satisfying the signal transmission requirements of the electrical connector.

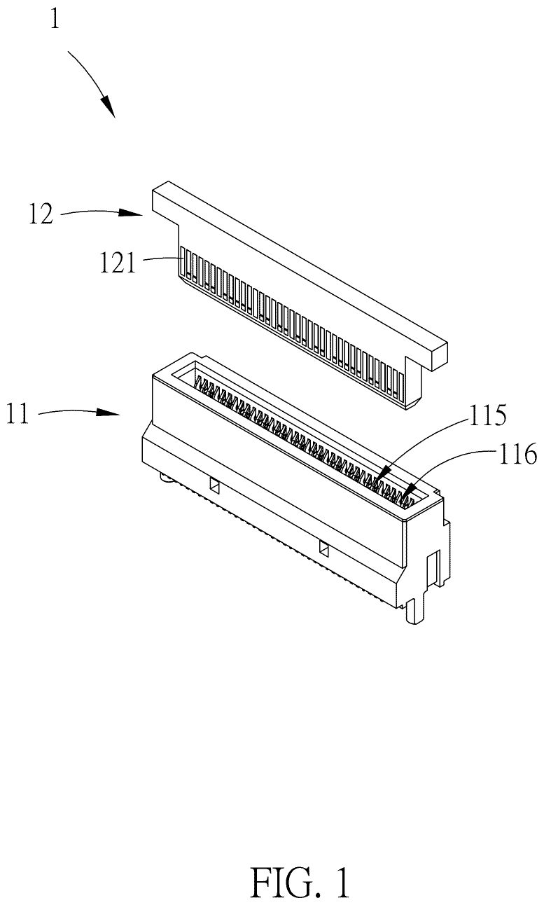

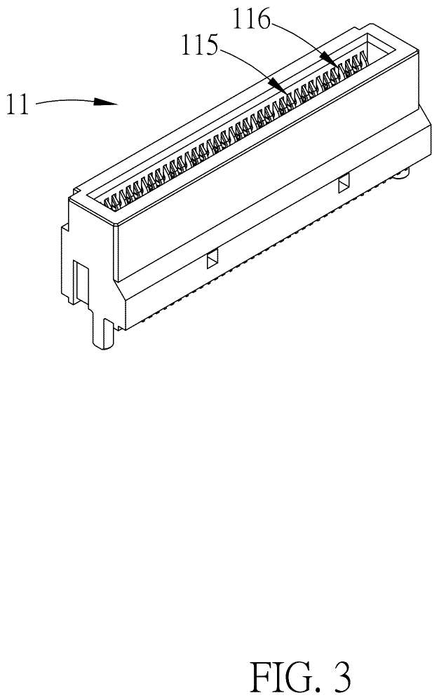

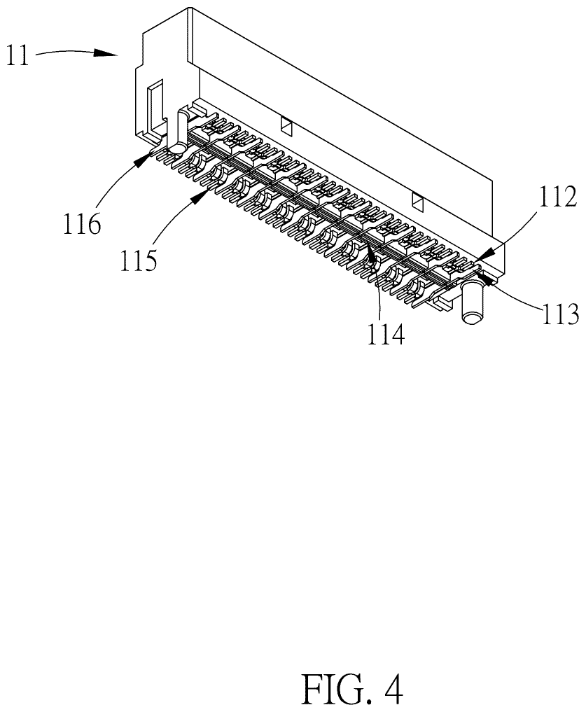

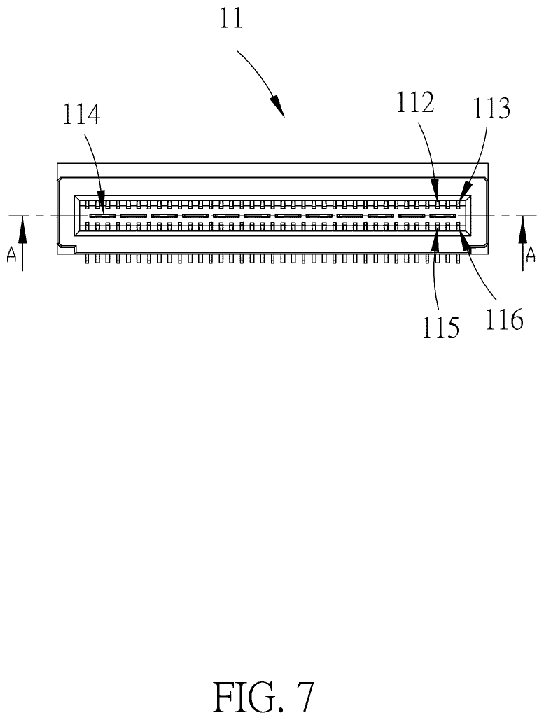

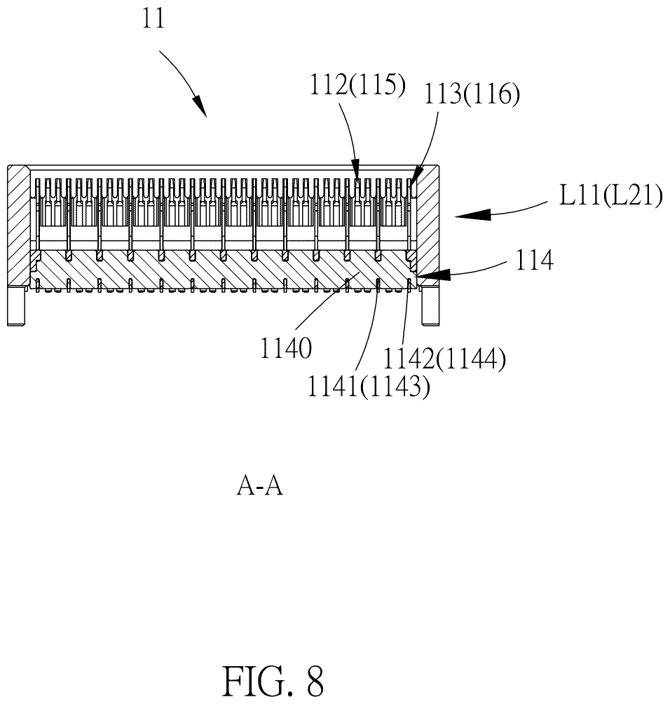

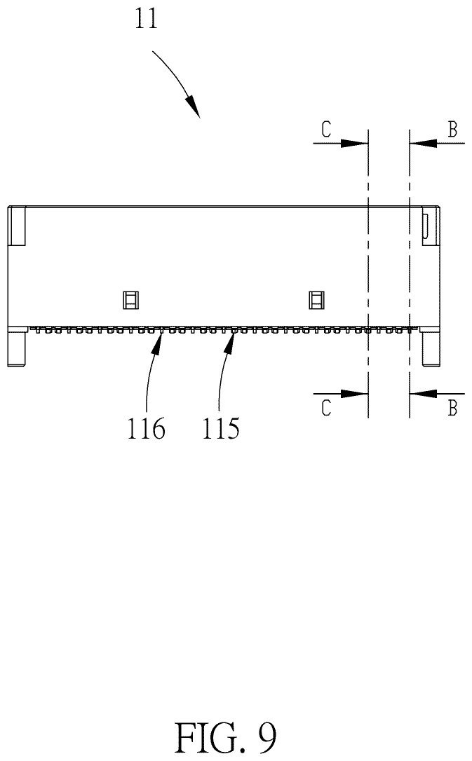

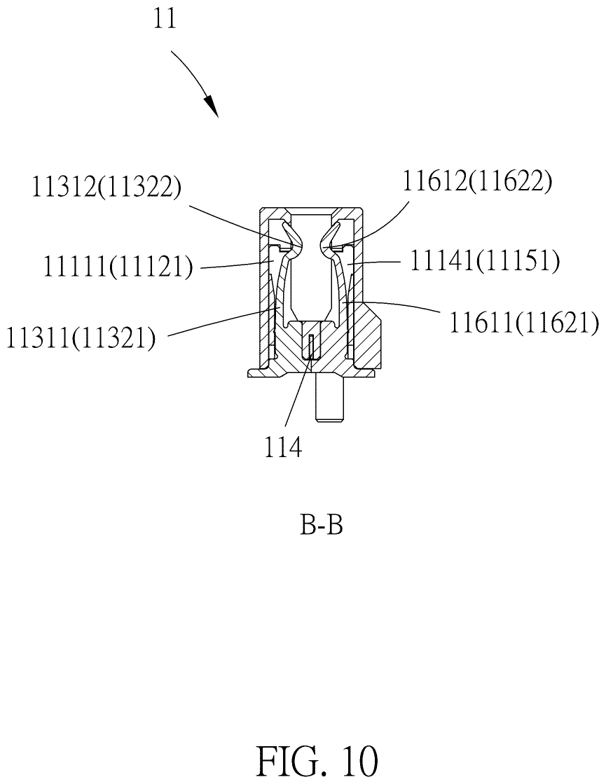

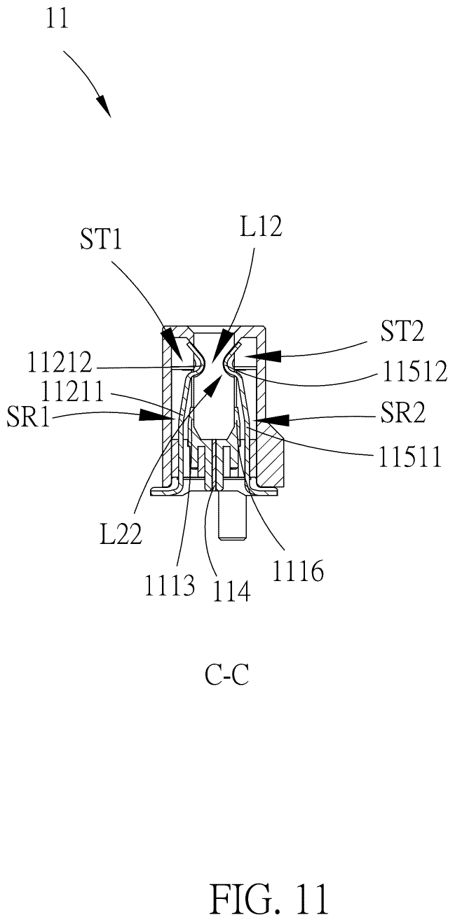

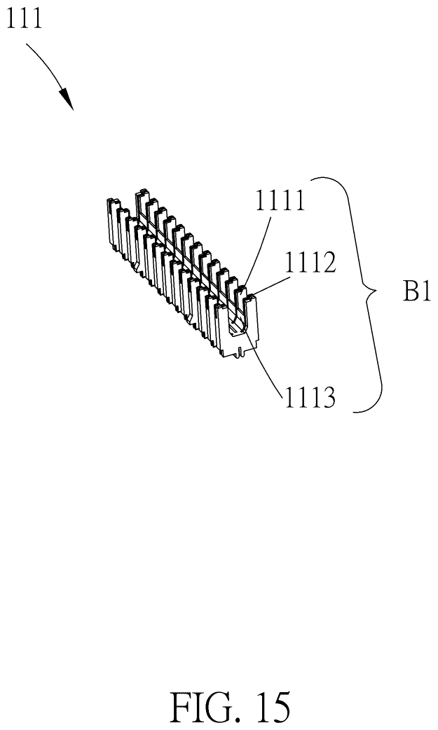

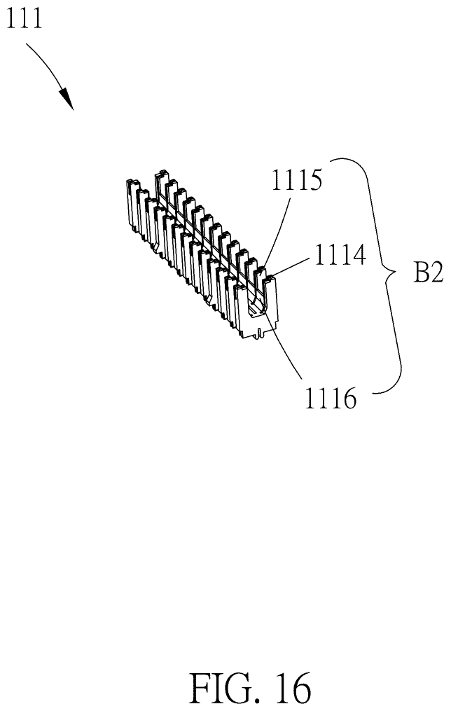

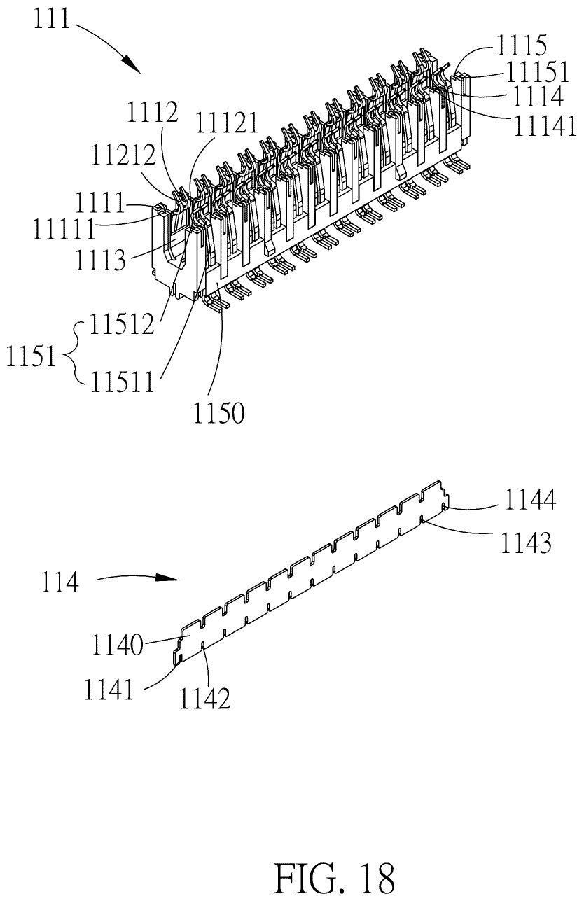

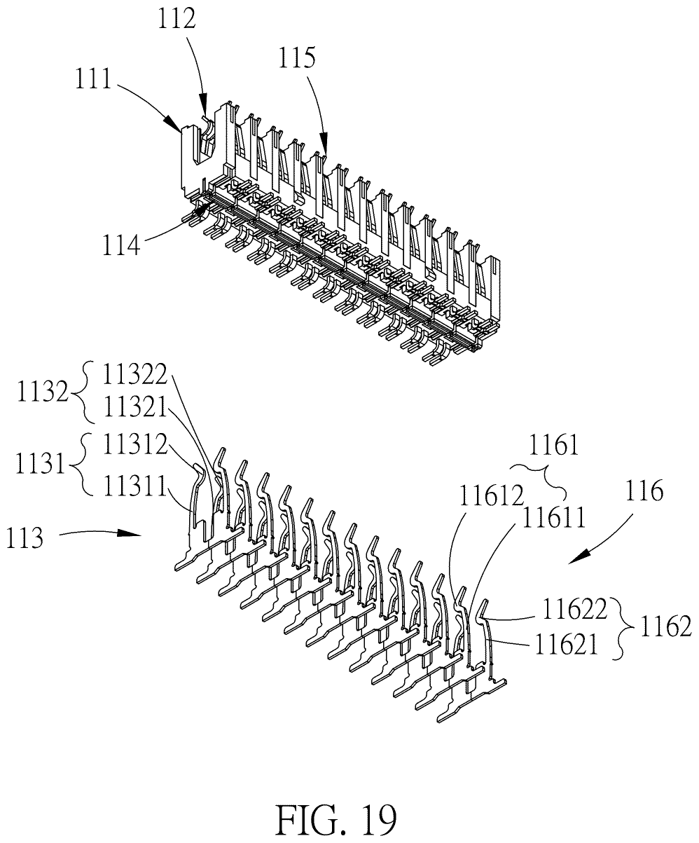

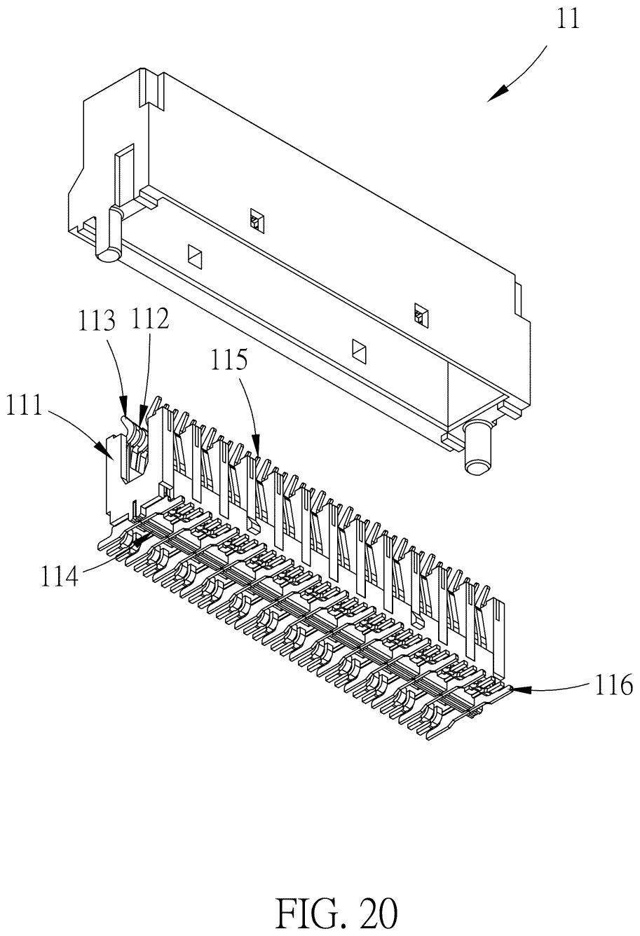

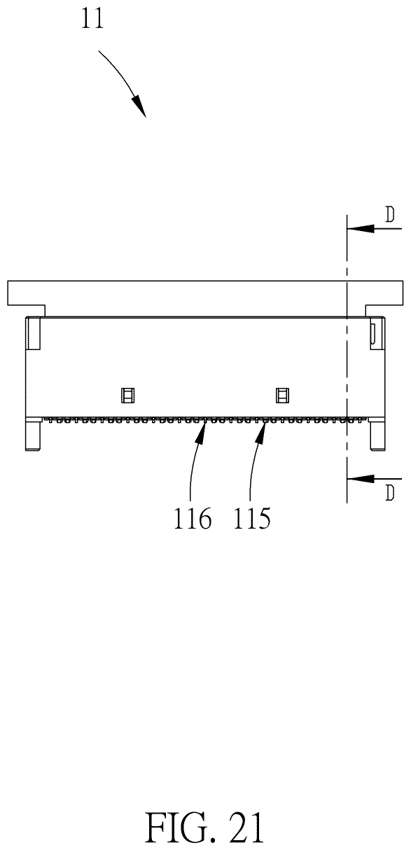

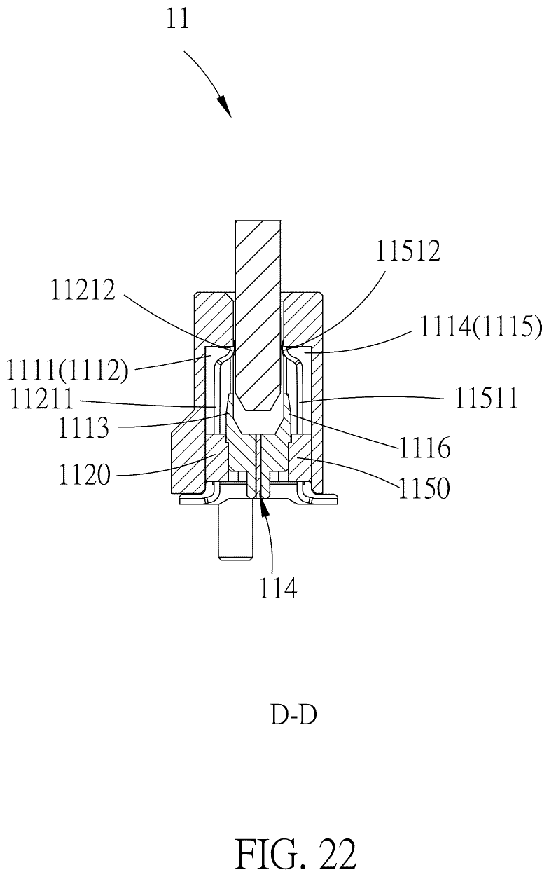

For a detailed description of the embodiments disclosed in the present application, please refer to FIGS. 1 to 22.

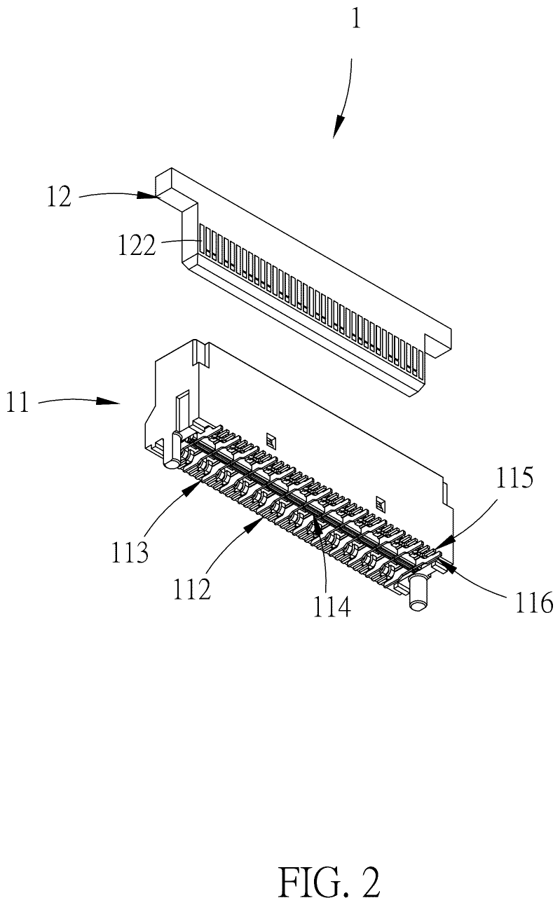

In the embodiments shown in FIGS. 1 to 2 of the present application, the connector assembly 1 comprises: an electrical connector 11 and a mating conductive component 12.

In the above embodiments, the electrical connector 11 may optionally be a cable-side connector or a board-side connector. The electrical connector 11 comprises: a conductive plastic base 111, a major signal terminal module 112, a major grounding terminal module 113, a minor signal terminal module 115, and a minor grounding terminal module 116. It should be noted that the conductive plastic base 111 may optionally be made of conductive plastic and provide electromagnetic wave absorption and/or electrical shielding.

The conductive plastic base 111 comprises a first major conductive plastic base signal terminal non-mating side shielding structure 1111, a second major conductive plastic base signal terminal non-mating side shielding structure 1112, a major conductive plastic base signal terminal mating side shielding structure 1113, a first minor conductive plastic base signal terminal non-mating side shielding structure 1114, a second minor conductive plastic base signal terminal non-mating side shielding structure 1115, and a minor conductive plastic base signal terminal mating side shielding structure 1116.

It should be noted that the major conductive plastic base signal terminal mating side shielding structure 1113, the first major conductive plastic base signal terminal non-mating side shielding structure 1111, and the second major conductive plastic base signal terminal non-mating side shielding structure 1112 form, by extension, a major conductive plastic base signal terminal root shielding space SR1. The first major conductive plastic base signal terminal non-mating side shielding structure 1111 and the second major conductive plastic base signal terminal non-mating side shielding structure 1112 form, by extension, a major conductive plastic base signal terminal mating shielding space ST1.

Furthermore, the minor conductive plastic base signal terminal mating side shielding structure 1116, the first minor conductive plastic base signal terminal non-mating side shielding structure 1114, and the second minor conductive plastic base signal terminal non-mating side shielding structure 1115 form, by extension, a minor conductive plastic base signal terminal root shielding space SR2. The first minor conductive plastic base signal terminal non-mating side shielding structure 1114 and the second minor conductive plastic base signal terminal non-mating side shielding structure 1115 form, by extension, a minor conductive plastic base signal terminal mating shielding space ST2.

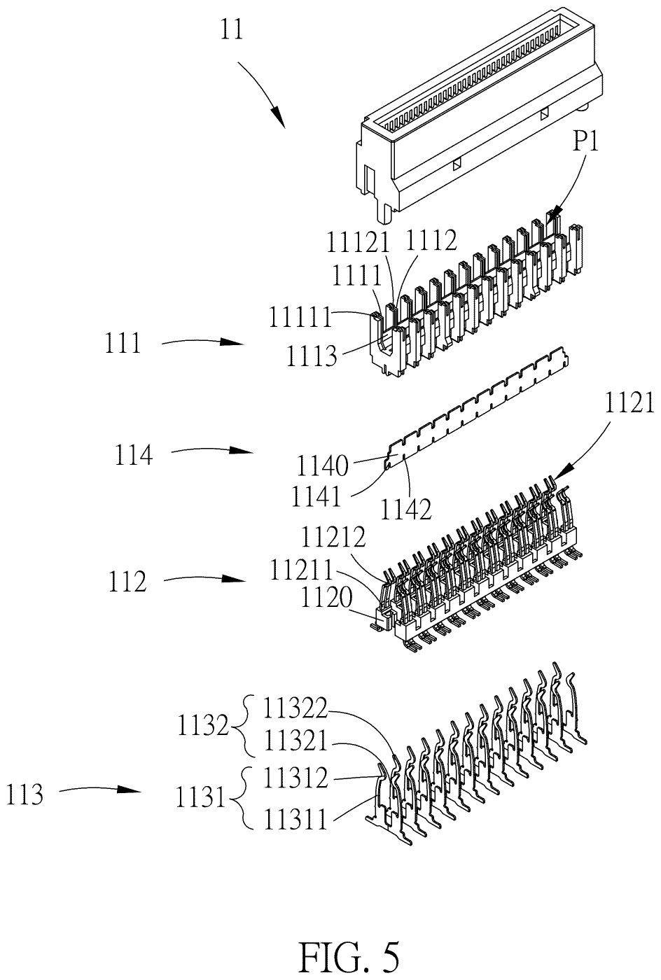

The major signal terminal module 112 comprises a major signal terminal 1121 and a major signal terminal insulating core 1120, wherein the major signal terminal 1121 is configured to transmit signals. As shown in FIGS. 5, 11, 17, and 22, the major signal terminal 1121 comprises a major signal terminal root structure 11211 and a major signal terminal mating structure 11212. The major signal terminal root structure 11211 provides support for the major signal terminal mating structure 11212, and the major signal terminal mating structure 11212 is configured to mate with the mating conductive component 12.

It should be noted that the major signal terminal insulating core 1120 is optionally made of an insulating material. In the above-mentioned embodiment, the major signal terminal insulating core 1120 respectively positions the major signal terminal 1121 and the conductive plastic base 111 to position the major signal terminal 1121 on the conductive plastic base 111 and to prevent the major signal terminal 1121 from electrically connecting to the conductive plastic base 111. Furthermore, the major signal terminal root structure 11211 enters the major conductive plastic base signal terminal root shielding space SR1, allowing the first major conductive plastic base signal terminal non-mating side shielding structure 1111 and the second major conductive plastic base signal terminal non-mating side shielding structure 1112 to respectively provide shielding for the major signal terminal root structure 11211 on a major non-mating side L11 of the major signal terminal 1121, thereby reducing interference in signal transmission through the major signal terminal root structure 11211 and satisfying the signal transmission requirements of the electrical connector 11. Additionally, the major conductive plastic base signal terminal mating side shielding structure 1113 provides shielding for the major signal terminal root structure 11211 on the major mating side L12 of the major signal terminal 1121, thereby reducing interference in signal transmission through the major signal terminal root structure 11211 and meeting the signal transmission requirements of the electrical connector 11. The major signal terminal mating structure 11212 enters the major conductive plastic base signal terminal mating shielding space ST1, enabling the first major conductive plastic base signal terminal non-mating side shielding structure 1111 and the second major conductive plastic base signal terminal non-mating side shielding structure 1112 to respectively provide shielding for the major signal terminal mating structure 11212 on the major non-mating side L11, thereby reducing interference in signal transmission through the major signal terminal mating structure 11212 and meeting the signal transmission requirements of the electrical connector 11.

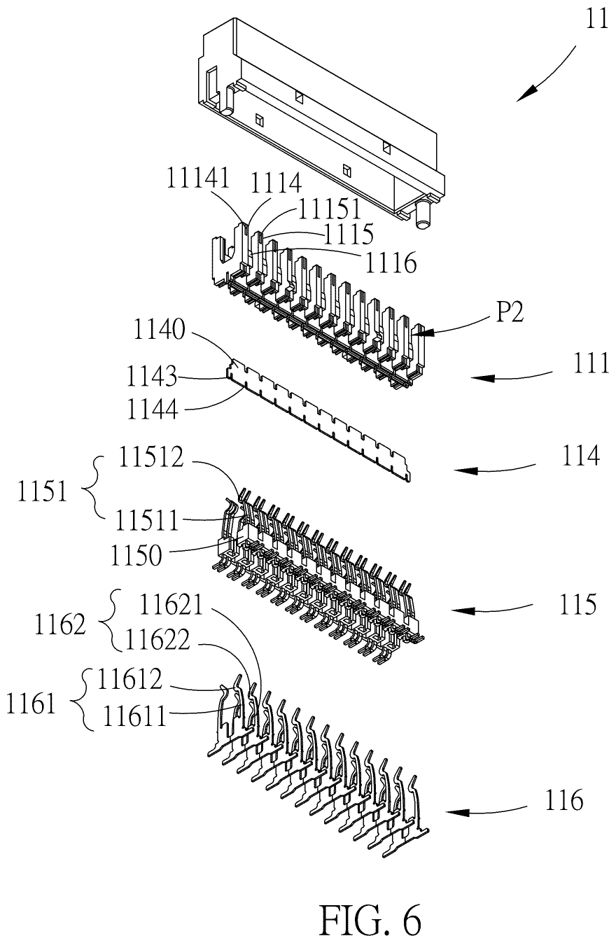

The minor signal terminal module 115 comprises a minor signal terminal 1151 and a minor signal terminal insulating core 1150. The minor signal terminal 1151 provides signal transmission. As shown in FIGS. 6, 11, 17, and 22, the minor signal terminal 1151 comprises a minor signal terminal root structure 11511 and a minor signal terminal mating structure 11512. The minor signal terminal root structure 11511 supports the minor signal terminal mating structure 11512, and the minor signal terminal mating structure 11512 is configured to mate with the mating conductive component 12.

It should be noted that the minor signal terminal insulating core 1150 is optionally made of an insulating material. In the above-mentioned embodiment, the minor signal terminal insulating core 1150 respectively positions the minor signal terminal 1151 and the conductive plastic base 111 to position the minor signal terminal 1151 in the conductive plastic base 111 and to prevent the minor signal terminal 1151 from electrically connecting to the conductive plastic base 111. Furthermore, the minor signal terminal root structure 11511 enters the minor conductive plastic base signal terminal root shielding space SR2, allowing the first minor conductive plastic base signal terminal non-mating side shielding structure 1114 and the second minor conductive plastic base signal terminal non-mating side shielding structure 1115 to respectively provide shielding for the minor signal terminal root structure 11511 on the minor non-mating side L21 of the minor signal terminal 115, thereby reducing interference in signal transmission through the minor signal terminal root structure 11511 and satisfying the signal transmission requirements of the electrical connector 11. Additionally, the minor conductive plastic base signal terminal mating side shielding structure 1116 provide shielding for the minor signal terminal root structure 11511 on the minor mating side L22 of the minor signal terminal 1151, thereby reducing interference in signal transmission through the minor signal terminal root structure 11511 and meeting the signal transmission requirements of the electrical connector 11. The minor signal terminal mating structure 11512 enters the minor conductive plastic base signal terminal mating shielding space ST2, enabling the first minor conductive plastic base signal terminal non-mating side shielding structure 1114 and the second minor conductive plastic base signal terminal non-mating side shielding structure 1115 to respectively provide shielding for the minor signal terminal mating structure 11512 on the minor non-mating side L21, thereby reducing interference in signal transmission through the minor signal terminal mating structure 11512 and meeting the signal transmission requirements of the electrical connector 11.

Furthermore, the minor conductive plastic base signal terminal mating side shielding structure 1116 and the major conductive plastic base signal terminal mating side shielding structure 1113 are optionally configured as symmetric structures, thereby simplifying the manufacturing of the conductive plastic base 111.

In the above-mentioned embodiment, the mating conductive component 12 is optionally a mating connector, a mating circuit board, or a mating conductor. The mating conductive component 12 comprises a major mating conductive component signal terminal mating structure 121 and a minor mating conductive component signal terminal mating structure 122. It should be noted that the mating conductive component 12 is configured to mate with the electrical connector 11 such that the major mating conductive component signal terminal mating structure 121 mates with the major signal terminal mating structure 11212 in the major conductive plastic base signal terminal mating shielding space ST1, and the minor mating conductive component signal terminal mating structure 122 mates with the minor signal terminal mating structure 11512 in the minor conductive plastic base signal terminal mating shielding space ST2.

It should be noted that in the above-described embodiments, when the mating conductive component 12 mates with the electrical connector 11, the major mating conductive component signal terminal mating structure 121 is located on the major mating side L12 of the major signal terminal 1121, and the minor mating conductive component signal terminal mating structure 122 is located on the minor mating side L22.

The major grounding terminal module 113 comprises a first major grounding terminal 1131 and a second major grounding terminal 1132. The first major grounding terminal 1131 comprises a first major grounding terminal root structure 11311 and a first major grounding terminal mating structure 11312, wherein the first major grounding terminal root structure 11311 provides support for the first major grounding terminal mating structure 11312, and the first major grounding terminal mating structure 11312 provides mating with the mating conductive component 12. The second major grounding terminal 1132 comprises a second major grounding terminal root structure 11321 and a second major grounding terminal mating structure 11322, wherein the second major grounding terminal root structure 11321 provides support for the second major grounding terminal mating structure 11322, and the second major grounding terminal mating structure 11322 provides mating with the mating conductive component 12.

It should be noted that in the above-described embodiments, the first major grounding terminal 1131 and the second major grounding terminal 1132 are respectively positioned by the conductive plastic base 111, such that the first major grounding terminal root structure 11311 and the second major grounding terminal root structure 11321 respectively enter the major conductive plastic base signal terminal root shielding space SR1, thereby enabling the first major grounding terminal root structure 11311 and the second major grounding terminal root structure 11321 to respectively provide shielding for the major signal terminal root structure 11211 on the major non-mating side L11, reducing the interference in the signal transmission of the major signal terminal root structure 11211, satisfying the signal transmission requirements of the electrical connector 11. Additionally, the first major grounding terminal mating structure 11312 and the second major grounding terminal mating structure 11322 respectively enter the major conductive plastic base signal terminal mating shielding space ST1, thereby enabling the first major grounding terminal mating structure 11312 and the second major grounding terminal mating structure 11322 to respectively provide shielding for the major signal terminal mating structure 11212 on the major non-mating side L11, reducing the interference in the signal transmission of the major signal terminal mating structure 11212, satisfying the signal transmission requirements of the electrical connector 11.

Optionally, in the embodiments shown in FIGS. 5, 10, and 19 of the present application, the first major grounding terminal 1131 and the second major grounding terminal 1132 are respectively positioned by the first major conductive plastic base signal terminal non-mating side shielding structure 1111 and the second major conductive plastic base signal terminal non-mating side shielding structure 1112, thereby positioning the first major grounding terminal 1131 and the second major grounding terminal 1132 in the conductive plastic base 111 and electrically connecting the first major grounding terminal 1131 and the second major grounding terminal 1132 to the conductive plastic base 111 for transmitting grounding signals.

The minor grounding terminal module 116 comprises a first minor grounding terminal 1161 and a second minor grounding terminal 1162. The first minor grounding terminal 1161 comprises a first minor grounding terminal root structure 11611 and a first minor grounding terminal mating structure 11612, wherein the first minor grounding terminal root structure 11611 provides support for the first minor grounding terminal mating structure 11612, and the first minor grounding terminal mating structure 11612 provides mating with the mating conductive component 12. The second minor grounding terminal 1162 comprises a second minor grounding terminal root structure 11621 and a second minor grounding terminal mating structure 11622, wherein the second minor grounding terminal root structure 11621 provides support for the second minor grounding terminal mating structure 11622, and the second minor grounding terminal mating structure 11622 provides mating with the mating conductive component 12.

It should be noted that in the above-described embodiments, the first minor grounding terminal 1161 and the second minor grounding terminal 1162 are respectively positioned by the conductive plastic base 111, such that the first minor grounding terminal root structure 11611 and the second minor grounding terminal root structure 11621 respectively enter the minor conductive plastic base signal terminal root shielding space SR2, thereby enabling the first minor grounding terminal root structure 11611 and the second minor grounding terminal root structure 11621 to respectively provide shielding for the minor signal terminal root structure 11511 on the minor non-mating side L21, reducing the interference in the signal transmission of the minor signal terminal root structure 11511, satisfying the signal transmission requirements of the electrical connector 11. Additionally, the first minor grounding terminal mating structure 11612 and the second minor grounding terminal mating structure 11622 respectively enter the minor conductive plastic base signal terminal mating shielding space ST2, thereby enabling the first minor grounding terminal mating structure 11612 and the second minor grounding terminal mating structure 11622 to respectively provide shielding for the minor signal terminal mating structure 11512 on the minor non-mating side L21, reducing the interference in the signal transmission of the minor signal terminal mating structure 11512, satisfying the signal transmission requirements of the electrical connector 11.

Optionally, in the embodiments shown in FIGS. 6, 10, and 19 of the present application, the first minor grounding terminal 1161 and the second minor grounding terminal 1162 are respectively positioned by the first minor conductive plastic base signal terminal non-mating side shielding structure 1114 and the second minor conductive plastic base signal terminal non-mating side shielding structure 1115, thereby positioning the first minor grounding terminal 1161 and the second minor grounding terminal 1162 in the conductive plastic base 111 and electrically connecting the first minor grounding terminal 1161 and the second minor grounding terminal 1162 to the conductive plastic base 111 for transmitting grounding signals.

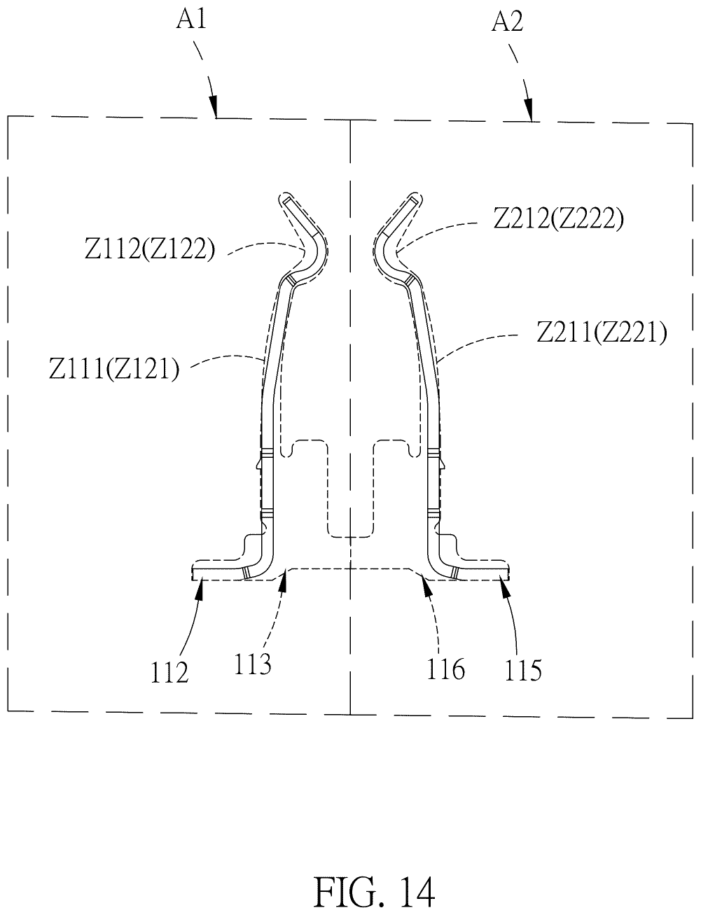

In the embodiment shown in FIG. 14 of the present application, the major signal terminal 1121 is located on a major signal terminal projection plane A1. The projection of the first major grounding terminal root structure 11311 and the second major grounding terminal root structure 11321 on the major signal terminal projection plane Al are respectively within a first major grounding terminal root structure projection region Z111 and a second major grounding terminal root structure projection region Z121. The major signal terminal root structure 11211 is located within the first major grounding terminal root structure projection region Z111 and the second major grounding terminal root structure projection region Z121. In this manner, the first major grounding terminal root structure 11311 and the second major grounding terminal root structure 11321 can provide shielding for the major signal terminal root structure 11211 to reduce the degree of interference affecting the signal transmission of the major signal terminal root structure 11211, thereby meeting the signal transmission requirements of the electrical connector 11. Furthermore, the projection of the first major grounding terminal mating structure 11312 and the second major grounding terminal mating structure 11322 on the major signal terminal projection plane A1 are respectively within a first major grounding terminal mating structure projection region Z112 and a second major grounding terminal mating structure projection region Z122. The major signal terminal mating structure 11212 is located within the first major grounding terminal mating structure projection region Z112 and the second major grounding terminal mating structure projection region Z122. In this manner, the first major grounding terminal mating structure 11312 and the second major grounding terminal mating structure 11322 can provide shielding for the major signal terminal mating structure 11212 to reduce the degree of interference affecting the signal transmission of the major signal terminal mating structure 11212, thereby meeting the signal transmission requirements of the electrical connector 11.

Additionally, the first minor grounding terminal 1161 is located on a minor signal terminal projection plane A2. The projection of the first minor grounding terminal root structure 11611 and the second minor grounding terminal root structure 11621 on the minor signal terminal projection plane A2 are respectively within a first minor grounding terminal root structure projection region Z211 and a second minor grounding terminal root structure projection region Z221. The minor signal terminal root structure 11511 is located within the first minor grounding terminal root structure projection region Z211 and the second minor grounding terminal root structure projection region Z221. In this manner, the first minor grounding terminal root structure 11611 and the second minor grounding terminal root structure 11621 can provide shielding for the minor signal terminal root structure 11511 to reduce the degree of interference affecting the signal transmission of the minor signal terminal root structure 11511, thereby meeting the signal transmission requirements of the electrical connector 11. Furthermore, the projection of the first minor grounding terminal mating structure 11612 and the second minor grounding terminal mating structure 11622 on the minor signal terminal projection plane A2 are respectively within a first minor grounding terminal mating structure projection region Z212 and a second minor grounding terminal mating structure projection region Z222. The minor signal terminal mating structure 11512 is located within the first minor grounding terminal mating structure projection region Z212 and the second minor grounding terminal mating structure projection region Z222. In this manner, the first minor grounding terminal mating structure 11612 and the second minor grounding terminal mating structure 11622 can provide shielding for the minor signal terminal mating structure 11512 to reduce the degree of interference affecting the signal transmission of the minor signal terminal mating structure 11512, thereby meeting the signal transmission requirements of the electrical connector 11.

In the embodiments shown in FIGS. 5, 10, and 17 to 18 of the present application, the first major conductive plastic base signal terminal non-mating side shielding structure 1111 has a first major conductive plastic base grounding terminal penetrating passage 11111, and the second major conductive plastic base signal terminal non-mating side shielding structure 1112 has a second major conductive plastic base grounding terminal penetrating passage 11121. The first major conductive plastic base grounding terminal penetrating passage 11111 provides penetrating for the first major grounding terminal 1131, and the second major conductive plastic base grounding terminal penetrating passage 11121 provides penetrating for the second major grounding terminal 1132, thereby preventing the first major conductive plastic base signal terminal non-mating side shielding structure 1111 from interfering with the first major grounding terminal 1131, and the second major conductive plastic base signal terminal non-mating side shielding structure 1112 from interfering with the second major grounding terminal 1132, which could otherwise affect the mating of the first major grounding terminal mating structure 11312 and the second major grounding terminal mating structure 11322 with the mating conductive component 12.

Additionally, the first minor conductive plastic base signal terminal non-mating side shielding structure 1114 has a first minor conductive plastic base grounding terminal penetrating passage 11141, and the second minor conductive plastic base signal terminal non-mating side shielding structure 1115 has a second minor conductive plastic base grounding terminal penetrating passage 11151. The first minor conductive plastic base grounding terminal penetrating passage 11141 provides penetrating for the first minor grounding terminal 1161, and the second minor conductive plastic base grounding terminal penetrating passage 11151 provides penetrating for the second minor grounding terminal 1162, thereby preventing the first minor conductive plastic base signal terminal non-mating side shielding structure 1114 from interfering with the first minor grounding terminal 1161, and the second minor conductive plastic base signal terminal non-mating side shielding structure 1115 from interfering with the second minor grounding terminal 1162, which could otherwise affect the mating of the first minor grounding terminal mating structure 11612 and the second minor grounding terminal mating structure 11622 with the mating conductive component 12.

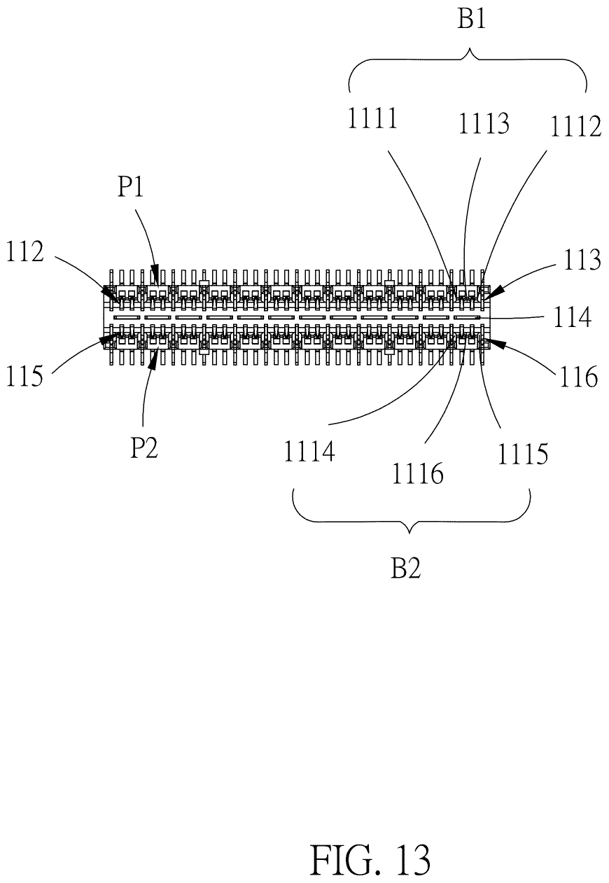

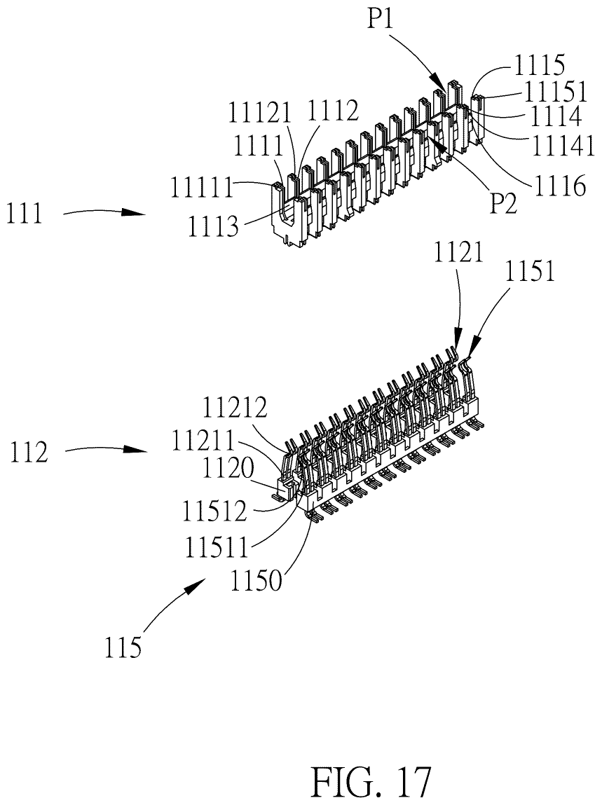

In the embodiments shown in FIGS. 13 and 17 of the present application, the conductive plastic base 111 further comprises a major conductive plastic base signal terminal penetrating passage P1 and a minor conductive plastic base signal terminal penetrating passage P2.

It should be noted that the major conductive plastic base signal terminal penetrating passage P1 is located between the first major conductive plastic base signal terminal non-mating side shielding structure 1111 and the second major conductive plastic base signal terminal non-mating side shielding structure 1112 to provide penetration for the major signal terminal 1121, thereby avoiding interference between the conductive plastic base 111 and the major signal terminal 1121, which could otherwise affect the docking of the major signal terminal mating structure 11212 with the mating conductive component 12.

Furthermore, the minor conductive plastic base signal terminal penetrating passage P2 is located between the first minor conductive plastic base signal terminal non-mating side shielding structure 1114 and the second minor conductive plastic base signal terminal non-mating side shielding structure 1115 to provide penetration for the minor signal terminal 1151, thereby avoiding interference between the conductive plastic base 111 and the minor signal terminal 1151, which could otherwise affect the docking of the minor signal terminal mating structure 11512 with the mating conductive component 12.

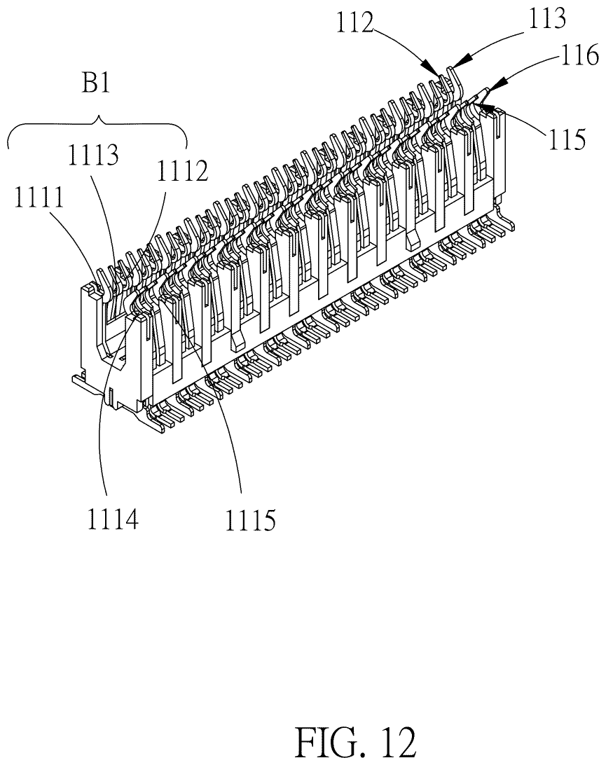

In the embodiments illustrated in FIGS. 12 to 13 and FIG. 15 of the present application, the major conductive plastic base signal terminal mating side shielding structure 1113 is connected to the first major conductive plastic base signal terminal non-mating side shielding structure 1111 and the second major conductive plastic base signal terminal non-mating side shielding structure 1112, forming a major conductive plastic base signal terminal shielding structure B1 for signal transmission. The major conductive plastic base signal terminal shielding structure B1 is a U-shaped configuration to enhance structural strength.

Additionally, the minor conductive plastic base signal terminal mating side shielding structure 1116 is connected to the first minor conductive plastic base signal terminal non-mating side shielding structure 1114 and the second minor conductive plastic base signal terminal non-mating side shielding structure 1115, forming a minor conductive plastic base signal terminal shielding structure B2 for signal transmission. The minor conductive plastic base signal terminal shielding structure B2 is a U-shaped configuration to enhance structural strength.

In the embodiments illustrated in FIGS. 5 to 6, FIGS. 8, and FIG. 18 of the present application, a bridging conductive component 114 is further included. The bridging conductive component 114 can optionally be made of conductive metal or conductive plastic and comprises a bridging conductive component body 1140, a first major bridging conductive component joining structure 1141, a second major bridging conductive component joining structure 1142, a first minor bridging conductive component joining structure 1143, and a second minor bridging conductive component joining structure 1144.

It should be noted that the bridging conductive component 114 is positioned by the conductive plastic base 111 to position the bridging conductive component 114 on the conductive plastic base 111 and to electrically connect the bridging conductive component 114 to the conductive plastic base 111 for signal transmission. Additionally, the major bridging conductive component body 1140 spans the major signal terminal 1121 and the minor signal terminal 1151, enabling the first major bridging conductive component joining structure 1141 to join the first major grounding terminal 1131, and the second major bridging conductive component joining structure 1142 to join the second major grounding terminal 1132. This ensures that the major bridging conductive component body 1140 electrically connects the first major grounding terminal 1131 and the second major grounding terminal 1132 for grounding signal transmission. Similarly, the first minor bridging conductive component joining structure 1143 joins the first minor grounding terminal 1161, and the second minor bridging conductive component joining structure 1144 joins the first minor grounding terminal 1161 and the second minor grounding terminal 1162, ensuring that the bridging conductive component body 1140 electrically connects the first minor grounding terminal 1161 and the second minor grounding terminal 1162 for grounding signal transmission.

In the aforementioned embodiments, the bridging conductive component body 1140 is located between the major signal terminal module 112 and the minor signal terminal module 115 to simplify the manufacturing of the electrical connector 11.

It should be noted that, in the embodiments of the present application, the aforementioned components may also be omitted. For example, the electrical connector may optionally include only: a conductive plastic base and a major signal terminal module. The conductive plastic base comprises a first major conductive plastic base signal terminal non-mating side shielding structure, a second major conductive plastic base signal terminal non-mating side shielding structure, and a major conductive plastic base signal terminal mating side shielding structure. Among them, the major conductive plastic base signal terminal mating side shielding structure, the first major conductive plastic base signal terminal non-mating side shielding structure, and the second major conductive plastic base signal terminal non-mating side shielding structure may extend to form a major conductive plastic base signal terminal root shielding space. The first major conductive plastic base signal terminal non-mating side shielding structure and the second major conductive plastic base signal terminal non-mating side shielding structure may also extend to form a major conductive plastic base signal terminal mating shielding space.

The major signal terminal module comprises a major signal terminal and a major signal terminal insulating core. The major signal terminal comprises a major signal terminal root structure and a major signal terminal mating structure. The major signal terminal root structure provides support to the major signal terminal mating structure. The major signal terminal insulating core is respectively positioned by the major signal terminal and the conductive plastic base, so that the major signal terminal root structure enters the major conductive plastic base signal terminal root shielding space, allowing the first major conductive plastic base signal terminal non-mating side shielding structure and the second major conductive plastic base signal terminal non-mating side shielding structure to respectively provide shielding for the major signal terminal root structure on the major non-mating side of the major signal terminal. Additionally, the major conductive plastic base signal terminal mating side shielding structure provides shielding for the major signal terminal root structure on the major mating side of the major signal terminal. Furthermore, the major signal terminal mating structure enters the major conductive plastic base signal terminal mating shielding space, enabling the first major conductive plastic base signal terminal non-mating side shielding structure and the second major conductive plastic base signal terminal non-mating side shielding structure to respectively provide shielding for the major signal terminal mating structure on the major non-mating side.

In addition, the connector assembly may optionally include only: an electrical connector and a mating conductive component. The mating conductive component comprises a major mating conductive component signal terminal mating structure. The mating conductive component is configured to mate with the electrical connector, enabling the major mating conductive component signal terminal mating structure to mate with the major signal terminal mating structure within the major conductive plastic base signal terminal mating shielding space. When the mating conductive component mates with the electrical connector, the major mating conductive component signal terminal mating structure is located on the major mating side.

In summary, the present application provides a connector assembly and its electrical connector. The electrical connector is capable of mating with a mating conductive component. The electrical connector comprises a conductive plastic base and a signal terminal. The signal terminal is configured to mate with the mating conductive component for signal transmission, while the conductive plastic base provides shielding for the signal terminal to reduce the degree of interference affecting signal transmission by the signal terminal, thereby meeting the signal transmission requirements of the electrical connector.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as formed by the appended claims.

1. An electrical connector, comprising:
a conductive plastic base, the conductive plastic base comprising a first major conductive plastic base signal terminal non-mating side shielding structure, a second major conductive plastic base signal terminal non-mating side shielding structure, and a major conductive plastic base signal terminal mating side shielding structure, wherein the major conductive plastic base signal terminal mating side shielding structure, the first major conductive plastic base signal terminal non-mating side shielding structure, and the second major conductive plastic base signal terminal non-mating side shielding structure can extend to form a major conductive plastic base signal terminal root shielding space, and the first major conductive plastic base signal terminal non-mating side shielding structure and the second major conductive plastic base signal terminal non-mating side shielding structure can also extend to form a major conductive plastic base signal terminal mating shielding space; and
a major signal terminal module, the major signal terminal module comprising a major signal terminal and a major signal terminal insulating core, wherein the major signal terminal comprises a major signal terminal root structure and a major signal terminal mating structure, wherein the major signal terminal root structure supports the major signal terminal mating structure, and the major signal terminal insulating core respectively positions the major signal terminal and the conductive plastic base, allowing the major signal terminal root structure to enter the major conductive plastic base signal terminal root shielding space, enabling the first major conductive plastic base signal terminal non-mating side shielding structure and the second major conductive plastic base signal terminal non-mating side shielding structure to respectively provide shielding for the major signal terminal root structure at a major non-mating side of the major signal terminal, and allows the major conductive plastic base signal terminal mating side shielding structure to provide shielding for the major signal terminal root structure at a major mating side of the major signal terminal, further allowing the major signal terminal mating structure enters the major conductive plastic base signal terminal mating shielding space, enabling the first major conductive plastic base signal terminal non-mating side shielding structure and the second major conductive plastic base signal terminal non-mating side shielding structure to respectively provide shielding for the major signal terminal mating structure on the major non-mating side.

2. The electrical connector of claim 1, wherein the conductive plastic base further comprises a major conductive plastic base signal terminal penetrating passage, and the major conductive plastic base signal terminal penetrating passage is located between the first major conductive plastic base signal terminal non-mating side shielding structure and the second major conductive plastic base signal terminal non-mating side shielding structure, to allow the major signal terminal to penetrate, preventing the conductive plastic base from interfering with the major signal terminal.

3. The electrical connector of claim 1, wherein the major conductive plastic base signal terminal mating side shielding structure is connected to the first major conductive plastic base signal terminal non-mating side shielding structure and the second major conductive plastic base signal terminal non-mating side shielding structure, forming a major conductive plastic base signal terminal shielding structure body, and the major conductive plastic base signal terminal shielding structure body is U-shaped.

4. The electrical connector of claim 1, further comprising:
a major grounding terminal module, the major grounding terminal module comprising a first major grounding terminal and a second major grounding terminal, wherein the first major grounding terminal comprises a first major grounding terminal root structure and a first major grounding terminal mating structure, and the first major grounding terminal root structure provides support for the first major grounding terminal mating structure, and the second major grounding terminal comprises a second major grounding terminal root structure and a second major grounding terminal mating structure, and the second major grounding terminal root structure provides support for the second major grounding terminal mating structure, and the first major grounding terminal and the second major grounding terminal are respectively positioned by the conductive plastic base, enabling the first major grounding terminal root structure and the second major grounding terminal root structure to respectively enter the major conductive plastic base signal terminal root shielding space, allowing the first major grounding terminal root structure and the second major grounding terminal root structure to respectively provide shielding for the major signal terminal root structure on the major non-mating side, enabling the first major grounding terminal mating structure and the second major grounding terminal mating structure to respectively enter the major conductive plastic base signal terminal mating shielding space, allowing the first major grounding terminal mating structure and the second major grounding terminal mating structure to respectively provide shielding for the major signal terminal mating structure on the major non-mating side.

5. The electrical connector of claim 4, wherein the first major grounding terminal and the second major grounding terminal are respectively positioned by the first major conductive plastic base signal terminal non-mating side shielding structure and the second major conductive plastic base signal terminal non-mating side shielding structure.

6. The electrical connector of claim 4, wherein the first major conductive plastic base signal terminal non-mating side shielding structure comprises a first major conductive plastic base grounding terminal penetrating passage, and the second major conductive plastic base signal terminal non-mating side shielding structure comprises a second major conductive plastic base grounding terminal penetrating passage, and the first major conductive plastic base grounding terminal penetrating passage provides penetrating for the first major grounding terminal, and the second major conductive plastic base grounding terminal penetrating passage provides penetrating for the second major grounding terminal, preventing the first major conductive plastic base signal terminal non-mating side shielding structure from interfering with the first major grounding terminal, and preventing the second major conductive plastic base signal terminal non-mating side shielding structure from interfering with the second major grounding terminal.

7. The electrical connector of claim 4, wherein the major signal terminal is located on a major signal terminal projection plane, and the first major grounding terminal root structure projects on a first major grounding terminal root structure projection area on the major signal terminal projection plane, and the second major grounding terminal root structure projects on a second major grounding terminal root structure projection area on the major signal terminal projection plane, and the major signal terminal root structure is projected within the first major grounding terminal root structure projection area and the second major grounding terminal root structure projection area; and the first major grounding terminal mating structure projects on a first major grounding terminal mating structure projection area on the major signal terminal projection plane, and the second major grounding terminal mating structure projects on a second major grounding terminal mating structure projection area on the major signal terminal projection plane, and the major signal terminal mating structure is projected within the first major grounding terminal mating structure projection area and the second major grounding terminal mating structure projection area.

8. The electrical connector of claim 4, further comprising a bridging conductive component, the bridging conductive component comprising a bridging conductive component body, a first major bridging conductive component joining structure, and a second major bridging conductive component joining structure, wherein the bridging conductive component is positioned by the conductive plastic base, such that the bridging conductive component body spans across the major signal terminal, causing the first major bridging conductive component joining structure to join the first major grounding terminal, and the second major bridging conductive component joining structure to join the second major grounding terminal, allowing the bridging conductive component body to be electrically connected with the first major grounding terminal and the second major grounding terminal.

9. The electrical connector of claim 1, wherein
the conductive plastic base further comprises a first minor conductive plastic base signal terminal non-mating side shielding structure, a second minor conductive plastic base signal terminal non-mating side shielding structure, and a minor conductive plastic base signal terminal mating side shielding structure, wherein the minor conductive plastic base signal terminal mating side shielding structure, the first minor conductive plastic base signal terminal non-mating side shielding structure, and the second minor conductive plastic base signal terminal non-mating side shielding structure form a minor conductive plastic base signal terminal root shielding space by extension, and the first minor conductive plastic base signal terminal non-mating side shielding structure and the second minor conductive plastic base signal terminal non-mating side shielding structure form a minor conductive plastic base signal terminal mating shielding space by extension; and
the electrical connector further comprises:
a minor signal terminal module, wherein the minor signal terminal module comprises a minor signal terminal and a minor signal terminal insulating core, the minor signal terminal comprising a minor signal terminal root structure and a minor signal terminal mating structure, wherein the minor signal terminal root structure supports the minor signal terminal mating structure, and the minor signal terminal insulating core respectively positions the minor signal terminal and the conductive plastic base, causing the minor signal terminal root structure to enter the minor conductive plastic base signal terminal root shielding space, such that the first minor conductive plastic base signal terminal non-mating side shielding structure and the second minor conductive plastic base signal terminal non-mating side shielding structure respectively provide shielding for minor signal terminal root structure on a the minor non-mating side of the minor signal terminal, and the minor conductive plastic base signal terminal mating side shielding structure provides shielding for the minor signal terminal root structure on the minor mating side of the minor signal terminal, allowing the minor signal terminal mating structure to enter the minor conductive plastic base signal terminal mating shielding space, such that the first minor conductive plastic base signal terminal non-mating side shielding structure and the second minor conductive plastic base signal terminal non-mating side shielding structure respectively provide shielding for the minor signal terminal mating structure on the minor non-mating side.

10. The electrical connector of claim 9, wherein the conductive plastic base further comprises a minor conductive plastic base signal terminal penetrating passage, the minor conductive plastic base signal terminal penetrating passage being located between the first minor conductive plastic base signal terminal non-mating side shielding structure and the second minor conductive plastic base signal terminal non-mating side shielding structure to provide penetrating for the minor signal terminal, while avoiding interference from the conductive plastic base with the minor signal terminal.

11. The electrical connector of claim 9, wherein the minor conductive plastic base signal terminal mating side shielding structure and the major conductive plastic base signal terminal mating side shielding structure are symmetrical structures.

12. The electrical connector of claim 9, wherein the minor conductive plastic base signal terminal mating side shielding structure is respectively connected to the first minor conductive plastic base signal terminal non-mating side shielding structure and the second minor conductive plastic base signal terminal non-mating side shielding structure to form a minor conductive plastic base signal terminal shielding structure body, the minor conductive plastic base signal terminal shielding structure body being a U-shaped structure body.

13. The electrical connector of claim 9, wherein the electrical connector further comprises a minor grounding terminal module, the minor grounding terminal module comprising a first minor grounding terminal and a second minor grounding terminal, the first minor grounding terminal comprising a first minor grounding terminal root structure and a first minor grounding terminal mating structure, wherein the first minor grounding terminal root structure provides support for the first minor grounding terminal mating structure, and the second minor grounding terminal comprising a second minor grounding terminal root structure and a second minor grounding terminal mating structure, wherein the second minor grounding terminal root structure provides support for the second minor grounding terminal mating structure, and the first minor grounding terminal and the second minor grounding terminal are respectively positioned by the conductive plastic base, such that the first minor grounding terminal root structure and the second minor grounding terminal root structure respectively enter the minor conductive plastic base signal terminal root shielding space, thereby causing the first minor grounding terminal root structure and the second minor grounding terminal root structure to respectively provide shielding for the minor signal terminal root structure on the minor non-mating side, and further causing the first minor grounding terminal mating structure and the second minor grounding terminal mating structure to respectively enter the minor conductive plastic base signal terminal mating shielding space, thereby causing the first minor grounding terminal mating structure and the second minor grounding terminal mating structure to respectively provide shielding for the minor signal terminal mating structure on the minor non-mating side.

14. The electrical connector of claim 13, wherein the first minor grounding terminal and the second minor grounding terminal are respectively positioned by the first minor conductive plastic base signal terminal non-mating side shielding structure and the second minor conductive plastic base signal terminal non-mating side shielding structure.

15. The electrical connector of claim 13, wherein the first minor conductive plastic base signal terminal non-mating side shielding structure comprises a first minor conductive plastic base grounding terminal penetrating passage, and the second minor conductive plastic base signal terminal non-mating side shielding structure comprises a second minor conductive plastic base grounding terminal penetrating passage, and the first minor conductive plastic base grounding terminal penetrating passage provides penetrating for the first minor grounding terminal, and the second minor conductive plastic base grounding terminal penetrating passage provides penetrating for the second minor grounding terminal, while avoiding interference from the first minor conductive plastic base signal terminal non-mating side shielding structure with the first minor grounding terminal, and avoiding interference from the second minor conductive plastic base signal terminal non-mating side shielding structure with the second minor grounding terminal.

16. The electrical connector of claim 13, wherein the first minor grounding terminal is located on a minor signal terminal projection plane, and the first minor grounding terminal root structure projects in a first minor grounding terminal root structure projection area on the minor signal terminal projection plane, and the second minor grounding terminal root structure projects in a second minor grounding terminal root structure projection area on the minor signal terminal projection plane, and the minor signal terminal root structure is projected in the first minor grounding terminal root structure projection area and the second minor grounding terminal root structure projection area; and the first minor grounding terminal mating structure projects in a first minor grounding terminal mating structure projection area on the minor signal terminal projection plane, and the second minor grounding terminal mating structure projects in a second minor grounding terminal mating structure projection area on the minor signal terminal projection plane, and the minor signal terminal mating structure is projected in the first minor grounding terminal mating structure projection area and the second minor grounding terminal mating structure projection area.

17. The electrical connector of claim 13, wherein the electrical connector further comprises a bridging conductive component, the bridging conductive component comprising a bridging conductive component body, a first minor bridging conductive component joining structure, and a second minor bridging conductive component joining structure, the bridging conductive component being positioned on the conductive plastic base, so that the bridging conductive component body spans over the minor signal terminal, causing the first minor bridging conductive component joining structure to be joined to the first minor grounding terminal, and causing the second minor bridging conductive component joining structure to be joined to the second minor grounding terminal, so that the bridging conductive component body electrically connects the first minor grounding terminal and the second minor grounding terminal.

18. The electrical connector of claim 17, wherein the bridging conductive component body is located between the major signal terminal module and the minor signal terminal module.

19. A connector assembly, the connector assembly comprising:
the electrical connector of claim 1; and
a mating conductive component, the mating conductive component comprising a major mating conductive component signal terminal mating structure, the mating conductive component being mated with the electrical connector, so that the major mating conductive component signal terminal mating structure mates with the major signal terminal mating structure within the major conductive plastic base signal terminal mating shielding space, wherein, when the mating conductive component is mated with the electrical connector, the major mating conductive component signal terminal mating structure is located on the major mating side.

20. A connector assembly, the connector assembly comprising:
the electrical connector of claim 9; and
a mating conductive component, the mating conductive component comprising a major mating conductive component signal terminal mating structure and a first minor mating conductive component signal terminal mating structure, the mating conductive component being mated with the electrical connector, so that the major mating conductive component signal terminal mating structure mates with the major signal terminal mating structure within the major conductive plastic base signal terminal mating shielding space, and the minor mating conductive component signal terminal mating structure mates with the minor signal terminal mating structure within the minor conductive plastic base signal terminal mating shielding space, wherein, when the mating conductive component is mated with the electrical connector, the major mating conductive component signal terminal mating structure is located on the major mating side of the major signal terminal, and the minor mating conductive component signal terminal mating structure is located on the minor mating side.
